(19) United States
(12) Patent Application Publication
(10) Pub. No.: US 2007/0024702 A1
(43) Pub. Date: Feb. 1, 2007

(54) Storage apparatus for digial/analog TV video/audio media

(76) Inventors: Wen-Ming Huang, Dasi Township (TW); Hsin-Ching Yin, Gangshan Township (TW); Chi-Wei Hsiao, Jhonghe City (TW); Chi-Hsien Wang, Yonghe City (TW); Wen-Fu Tsai, Renwu Township (TW); Shu-Hui Gong, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/491,295

(22) Filed: Jul. 24, 2006

(30) Foreign Application Priority Data
Aug. 1, 2005 (TW) 094213090

(51) Int. Cl. H04N 7/18

(52) U.S. Cl. 348/83

(57) ABSTRACT

A storage apparatus for DTV/ATV/DAB/ANALOG AUDIO BROADCASTING media is provided, including a USB hub or USB serial interface engine (SIE), at least a DTV/ATV/DAB/ANALOG AUDIO BROADCASTING interface converter, a video/audio decoding interface and a plurality of storage media interfaces. The upstream port of the USB hub or the USB serial interface engine is connected to a USB interface of an electronic device. The DTV/ATV/DAB/ANALOG AUDIO BROADCASTING interface converter and a plurality of storage media interfaces are connected respectively to the downstream ports of the USB hub or endpoints of USB serial interface engine. The DTV/ATV/DAB/ANALOG AUDIO BROADCASTING interface converter can convert DTV/ATV/DAB/ANALOG AUDIO BROADCASTING signals into data uploaded through the USB hub or the USB serial interface engine to the electronic device with the USB interface for playing. The electronic device can process the data, such as compression, filtering, and so on, and then downloads the processed data to each storage media interface through the USB hub or the USB serial interface engine; or alternatively, the video/audio processor can transmit the processed data through video/audio storage interface converter to storage media interface for storing without going through the USB hub or the USB serial interface engine, and the electronic device with the USB interface.

### BACKGROUND OF THE INVENTION

1. Field of the Invention

The present invention relates to a storage apparatus for digital/analog TV video/audio media and, more particularly, to a portable storage apparatus for storing digital/analog TV video and broadcasting audio.

2. The Related Arts

The analog/digital TV (ATV/DTV) and analog/digital audio broadcasting (ANALOG AUDIO BROADCASTING/DAB) create a new era for home audiovisual entertainment. Especially, as the DTV and DAB become popular among households, more channels are available for information and entertainment transmission to improve the life quality. However, the conventional DTV and DAB tend to provide one-way broadcasting in application, such as using digital set-top box to connect to high definition TV (HDTV) or digital stereo systems for high resolution audiovisual. There is a general lack of integrating multimedia applications, such as the on-the-fly recording of DTV and DAB programs, or editing of stored DTV and DAB contents. This restricts the impact and the functions of DTV and DAB.

Several solutions have been proposed in various patents. For example, Taiwan Patent No. 515200 discloses a method and device for the set-top box for internal media format conversion and program downloading. The program interface has a complicated structure, which is expensive to build and difficult to use. Furthermore, the disclosed device does not provide on-the-fly recording while the user viewing the DTV or DAB program, which is a major disadvantage for DTV/DAB popularity.

U.S. Patent Publication No. 2004/0,264,929, entitled “Information Storage Medium Storing Information for Generating DTV Stream, and Method and Apparatus for Converting DTV Stream”, teaches a method for converting DVD audiovisual media format, such as MPEG-2 TS, MPEG-4 and MPEG-7, to DTV stream of DTV format for DTV broadcasting. The conversion method and structure are only for one-way data format conversion to provide DTV broadcasting. No function is provided for DTV/DAB data conversion storage. Therefore, the disclosed method provides only a new source for DTV broadcasting, and little to the two-way application of DTV.

### SUMMARY OF THE INVENTION

The present invention has been made to overcome the aforementioned drawbacks of the conventional technologies. The primary object of the present invention is to provide a storage apparatus for storing digital/analog TV video (DTV/ATV) and digital/analog audio broadcasting (DAB/ANALOG AUDIO BROADCASTING) with at least a digital/analog TV video/audio interface converter for converting ATV/DTV or ANALOG AUDIO BROADCASTING/DAB to an electronic device with a USB interface for playing and provides to other portable storage media storage for storing.

Another object of the present invention is to provide a storage apparatus for storing DTV/ATV/DAB/ANALOG AUDIO BROADCASTING with at least a USB hub or a USB serial interface engine and a plurality of storage media interfaces. The data can be transmitted through the USB hub or the USB serial interface engine to the electronic device with a USB interface for processing, such as compression, filtering and format conversion, and then, transmitted to a plurality of storage media interfaces through the USB hub or the USB serial interface engine. The storage media interfaces are connected to portable storage devices, such as flash memory sticks, card reader, CD-RW, DVD-RW or hard disk. The DTV/ATV, ANALOG AUDIO BROADCASTING, DAB can then be stored in these portable storage media.

Another object of the present invention is to provide a storage apparatus for storing DTV/ATV/DAB/ANALOG AUDIO BROADCASTING where the DTV/ATV/DAB/ANALOG AUDIO BROADCASTING interface converter can transmit the converted format to each storage media for storing data in portable storage media without going through the USB hub or USB serial interface engine and electronic device with a USB interface.

To achieve the aforementioned objects, the present invention provides a storage apparatus for DTV/ATV/DAB/ANALOG AUDIO BROADCASTING media, including at least a USB hub or USB serial interface engine, a DTV/ATV/DAB/ANALOG AUDIO BROADCASTING interface converter, a video/audio storage interface converter, a video/audio data processor and a plurality of storage media interface, where the upstream port of the USB hub or the USB serial interface engine is connected to a USB interface of an electronic device. The DTV/ATV/DAB/ANALOG AUDIO BROADCASTING interface converter and a plurality of storage media interfaces are connected respectively to the downstream ports of the USB hub or USB serial interface engine. The DTV/ATV/DAB/ANALOG AUDIO BROADCASTING interface converter can convert DTV/ATV/DAB/ANALOG AUDIO BROADCASTING signals into data uploaded through the USB hub or the USB serial interface engine to the electronic device with the USB interface for playing. The electronic device can process the data, such as compression, filtering, and so on, and then downloads the processed data to each storage media interface through the USB hub or the USB serial interface engine; or alternatively, the video/audio processor can transmit the processed data through video/audio storage interface converter to storage media interface for storing without going through the USB hub or the USB serial interface engine, and the electronic device with the USB interface. The storage media interfaces are connected respectively to portable storage devices, such as flash memory, CD-RW, DVD-RW and hard disk, so that the DTV/ATV/Dab/ANALOG AUDIO BROADCASTING data can be stored in the portable storage media. The present invention forms a portable, two-way and multi-path recording storage media apparatus for DTV/ATV/DAB/ANALOG AUDIO BROADCASTING data.

The advantage of the present invention is to enable the playing, storing, and on-the-fly recording of the DTV/ATV/DAB/ANALOG AUDIO BROADCASTING data through a simple and inexpensive structure and method. With the present invention, the DTV/ATV/Dab/ANALOG AUDIO BROADCASTING data can be played as well as stored in portable storage devices, such as flash memory, CD-RW, DVD-RW and hard disk for various further applications.

These and other objects, features, and advantages of the present invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a system block diagram of the present invention;

FIG. 2 is a system block diagram of the present invention;

FIG. 3 is a system block diagram of the present invention;

FIG. 4 is a system block diagram of the present invention; and

FIG. 5 is a flowchart of the present invention.

### DETAILED DESCRIPTION OF THE INVENTION

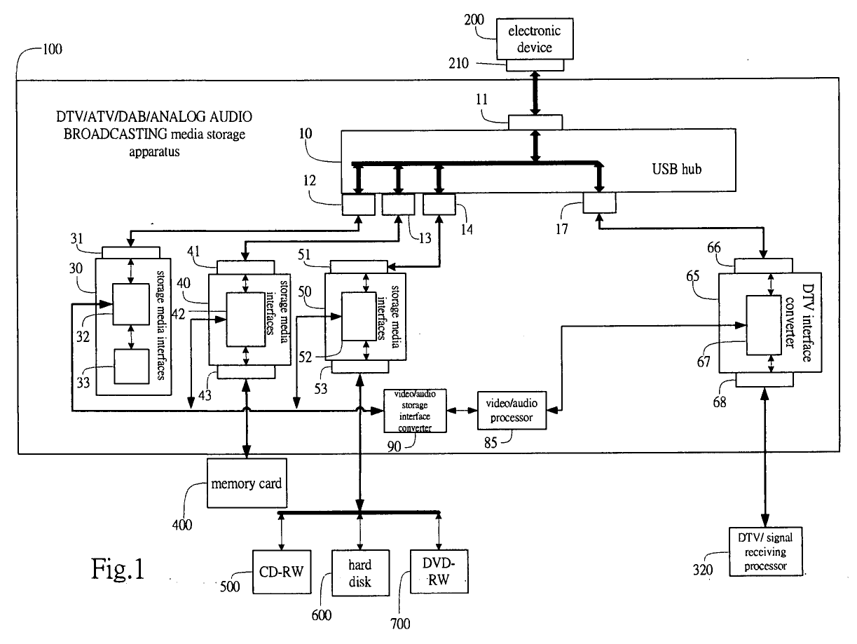

With reference to the drawings and in particular to FIG. 1, which shows DTV/ATV/Dab/ANALOG AUDIO BROADCASTING media storage apparatus constructed in accordance with a first embodiment of the present invention, the DTV/ATV/Dab/ANALOG AUDIO BROADCASTING media storage apparatus of the present invention, generally designated with reference numeral 100, comprises at least a USB hub 10, a DTV interface converter 65, and a plurality of storage media interfaces 30, 40, 50. The USB hub 10 is connected to an upstream port 11 and a plurality of downstream ports 12, 13, 14, 17. The upstream port 11 is connected to a USB interface 210 of an electronic device 200 for two-way data communication between downstream ports 12, 13, 14, 17 and the electronic device 200.

The aforementioned DTV interface converter 65 comprises a USB controller 66, a DTV signal processor 67, and a DTV signal input interface 68. The USB controller 66 is connected to the downstream port 17 of the USB hub 10 to provide conversion of DTV signal into a format suitable for playing on the electronic device 200. The DTV signal processor 67 is connected to the USB controller 66, which is connected to the USB hub 10. The upstream port 11 of the USB hub 10 transmits the processed DTV data to the electronic device 200 for playing or storage.

The aforementioned storage media interfaces 30, 40, 50 are not limited to any specific type. In the present invention, the portable storage media interfaces, such as flash memory sticks, card reader, and ATA/ATAPI CD-RW and hard disk, are used as embodiment. Other equivalent portable storage media interfaces are also within the scope of the present invention. The storage media interface 30 comprises a USB controller 31, a flash memory access controller 32, and at least a flash memory 33. The USB controller 31 is connected to a downstream port 13 of the USB hub 10 to form a two-way USB-type data connection between the storage media interface 30 and the USB hub 10. The flash memory access controller 32 is to control the data access, and the flash memory 33 is connected to and controlled by the flash memory access controller 32. The flash memory 33 is not limited to any specific type. The present invention uses NAND FLASH or NOR FLASH as embodiment for explanation.

The aforementioned flash memory access controller 32 is connected to the USB controller 31 to transmit, through the USB hub 10, digital data converted by the DTV interface converter 65 to the electronic device 200 for playing or storage; alternatively, data processed, such as compression, filtering, and format conversion, by the electronic device 200 can be downloaded for storing in the flash memory 33. In addition, data can be compressed, filtered and/or format converted by the video/audio processor 85 and the video/audio storage interface converter 90 and then transmitted to the flash memory access controller 32 for storing in the flash memory 33 without going through the USB hub 10 and the electronic device 200. In this way, object of storing the DTV data in the portable flash memory storage media is achieved.

The aforementioned storage media interface 40 comprises a USB controller 41, a card reader controller 42, and a memory connector 43. The USB controller 41 is connected to a downstream port 14 of the USB hub 10 to form a two-way USB-type data connection between the storage media interface 40 and the USB hub 10. The card reader controller 42 is to control the data access, and the memory connector 43 is to provide external connection to at least a memory card 400. The memory card 400 can be CF/SD/MMC/XD/SM/MS/MSPRO/MS DUO, and so on, type of flash memory card. The memory connector 43 is connected to the card reader controller 42 so that the memory card 400 is controlled by the card reader controller 42. The aforementioned card reader controller 42 is connected to the USB controller 41 to transmit, through the USB hub 10, digital data converted by the DTV interface converter 65 to the electronic device 200 for playing or storage; alternatively, data processed, such as compression, filtering, and format conversion, by the electronic device 200 can be downloaded for storing in the memory card 400. In addition, data can be compressed, filtered and/or format converted by the video/audio processor 85 and the video/audio storage interface converter 90 and then transmitted laterally to the card reader controller 42 for storing in the memory card 400 without going through the USB hub 10 and the electronic device 200. In this way, object of storing the DTV data in the portable card reader storage media is achieved.

The aforementioned storage media interface 50 comprises a USB controller 51, an ATA/ATAPI interface controller 52, and a plurality of interface connectors 53, 54, 55. The USB controller 51 is connected to a downstream port 15 of the USB hub 10 to form a two-way USB-type data connection between the storage media interface 50 and the USB hub 10. The ATA/ATAPI controller 52 is to control the data access, and the interface connectors 53, 54, 55 are to provide external connection to a CD-RW 500, a hard disk 600, and a DVD-RW 700, respectively. The CD-RW 500, the hard disk 600, and the DVD-RW 700 have an ATA/ATAPI type interface. The interface connectors 53, 54, 55 are connected to the ATA/ATAPI controller 52 so that the D-RW 500, the hard disk 600, and the DVD-RW 700 are controlled by the ATA/ATAPI controller 52. The aforementioned ATA/ATAPI controller 52 is connected to the USB controller 51 to transmit, through the USB hub 10, digital data converted by the DTV interface converter 65 to the electronic device 200 for playing or storage; alternatively, data processed, such as compression, filtering, and format conversion, by the electronic device 200 can be downloaded for storing in the D-RW 500, the hard disk 600, and the DVD-RW 700. In addition, data can be compressed, filtered and/or format converted by the video/audio processor 85 and the video/audio storage interface converter 90 and then transmitted laterally to the ATA/ATAPI controller 52 for storing in the D-RW 500, the hard disk 600, and the DVD-RW 700 without going through the USB hub 10 and the electronic device 200. In this way, object of storing the DTV data in the portable D-RW, hard disk, and DVD-RW storage media is achieved.

The aforementioned storage media interfaces 30, 40, 50 are not limited to the individual circuit elements as shown in FIG. 1. The storage media interfaces 30, 40, 50 can be integrated into an IC or a circuit module.

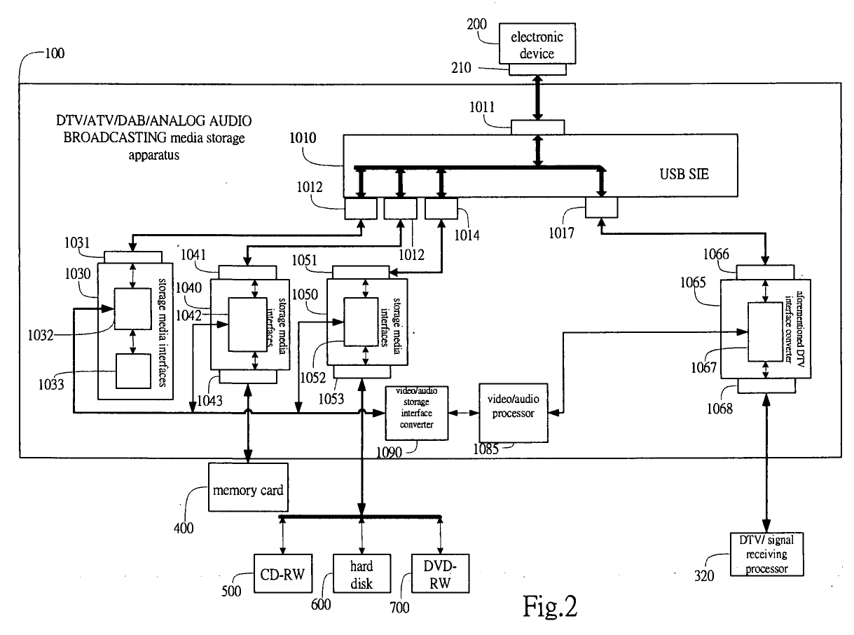

FIG. 2 shows a second embodiment of the present invention. A DTV/ATV/Dab/ANALOG AUDIO BROADCASTING media storage apparatus 100 comprises a USB serial interface engine (SIE) 1010, a DTV interface converter 1065, and a plurality of storage media interfaces 1030, 1040, 1050. The USB SIE 1010 comprises an upstream port 1011 and a plurality of endpoints 1012, 1013, 1014, 1017. The upstream port 1011 is connected to a USB interface 210 of an electronic device 200 for one-way/two-way data communication between the endpoints 1012, 1013, 1014, 1017 and the electronic device 200.

The aforementioned DTV interface converter 1065 comprises a USB endpoint interface 1066, a DTV signal processor 1067, and a DTV signal input interface 1068. The USB endpoint interface 1066 is connected to the endpoint 1017 of the USB SIE 1010 to provide conversion of DTV signal into a format suitable for playing on the electronic device 200. The DTV signal processor 1067 is connected to the USB endpoint interface 1066, which is connected to the USB SIE 1010. The upstream port 1011 of the USB SIE 1010 transmits the processed DTV data to the electronic device 200 for playing or storage.

The aforementioned storage media interfaces 1030, 1040, 1050 are not limited to any specific type. In the present invention, the portable storage media interfaces, such as flash memory sticks, card reader, and ATA/ATAPI CD-RW and hard disk, are used as embodiment. Other equivalent portable storage media interfaces are also within the scope of the present invention. The storage media interface 1030 comprises a USB endpoint interface 1031, a flash memory access controller 1032, and at least a flash memory 1033. The USB endpoint interface 1031 is connected to an endpoint 13 of the USB SIE 1010 to form a one-way/two-way USB-type data connection between the storage media interface 1030 and the USB SIE 1010. The flash memory access controller 1032 is to control the data access, and the flash memory 1033 is connected to and controlled by the flash memory access controller 1032. The aforementioned flash memory access controller 1032 is connected to the USB endpoint interface 1031 to transmit, through the USB SIE 1010, digital data converted by the DTV interface converter 1065 to the electronic device 200 for playing or storage; alternatively, data processed, such as compression, filtering, and format conversion, by the electronic device 200 can be downloaded for storing in the flash memory 1033. In addition, data can be compressed, filtered and/or format converted by the video/audio processor 1085 and the video/audio storage interface converter 1090 and then transmitted to the flash memory access controller 1032 for storing in the flash memory 1033 without going through the USB SIE 1010 and the electronic device 200. In this way, object of storing the DTV data in the portable flash memory storage media is achieved.

The aforementioned storage media interface 1040 comprises a USB endpoint interface 1041, a card reader controller 1042, and a memory connector 1043. The USB endpoint interface 1041 is connected to an endpoint 1014 of the USB SIE 1010 to form a one-way/two-way USB-type data connection between the storage media interface 1040 and the USB SIE 1010. The card reader controller 1042 is to control the data access, and the memory connector 1043 is to provide external connection to at least a memory card 400. The memory card 400 can be CF/SD/MMC/XD/SM/MS/MSPRO/MS DUO, and so on, type of flash memory card. The memory connector 1043 is connected to the card reader controller 1042 so that the memory card 400 is controlled by the card reader controller 1042. The aforementioned card reader controller 1042 is connected to the USB endpoint interface 1041 to transmit, through the USB SIE 1010, digital data converted by the DTV interface converter 1065 to the electronic device 200 for playing or storage; alternatively, data processed, such as compression, filtering, and format conversion, by the electronic device 200 can be downloaded for storing in .2memory card 400. In addition, data can be compressed, filtered and/or format converted by the video/audio processor 1085 and the video/audio storage interface converter 1090 and then transmitted laterally to the card reader controller 1042 for storing in the memory card 400 without going through the USB SIE 1010 and the electronic device 200. In this way, object of storing the DTV data in the portable card reader storage media is achieved.

The aforementioned storage media interface 1050 comprises a USB endpoint interface 1051, an ATA/ATAPI interface controller 1052, and a plurality of interface connectors 1053, 1054, 1055. The USB endpoint interface 1051 is connected to an endpoint 1015 of the USB SIE 1010 to form a one-way/two-way USB-type data connection between the storage media interface 1050 and the USB SIE 1010. The ATA/ATAPI controller 1052 is to control the data access, and the interface connectors 1053, 1054, 1055 are to provide external connection to a CD-RW 500, a hard disk 600, and a DVD-RW 700, respectively. The CD-RW 500, the hard disk 600, and the DVD-RW 700 have an ATA/ATAPI type interface. The interface connectors 1053, 1054, 1055 are connected to the ATA/ATAPI controller 1052 so that the CD-RW 500, the hard disk 600, and the DVD-RW 700 are controlled by the ATA/ATAPI controller 1052. The aforementioned ATA/ATAPI controller 1052 is connected to the USB endpoint interface 1051 to transmit, through the USB SIE 1010, digital data converted by the DTV interface converter 1065 to the electronic device 200 for playing or storage; alternatively, data processed, such as compression, filtering, and format conversion, by the electronic device 200 can be downloaded for storing in the CD-RW 500, the hard disk 600, and the DVD-RW 700. In addition, data can be compressed, filtered and/or format converted by the video/audio processor 1085 and the video/audio storage interface converter 1090 and then transmitted laterally to the ATA/ATAPI controller 1052 for storing in the CD-RW 500, the hard disk 600, and the DVD-RW 700 without going through the USB SIE 1010 and the electronic device 200. In this way, object of storing the DTV data in the portable D-RW, hard disk, and DVD-RW storage media is achieved.

The aforementioned storage media interfaces 1030, 1040, 1050 are not limited to the individual circuit elements as shown in FIG. 2. The storage media interfaces 1030, 1040, 1050 can be integrated into an IC or a circuit module.

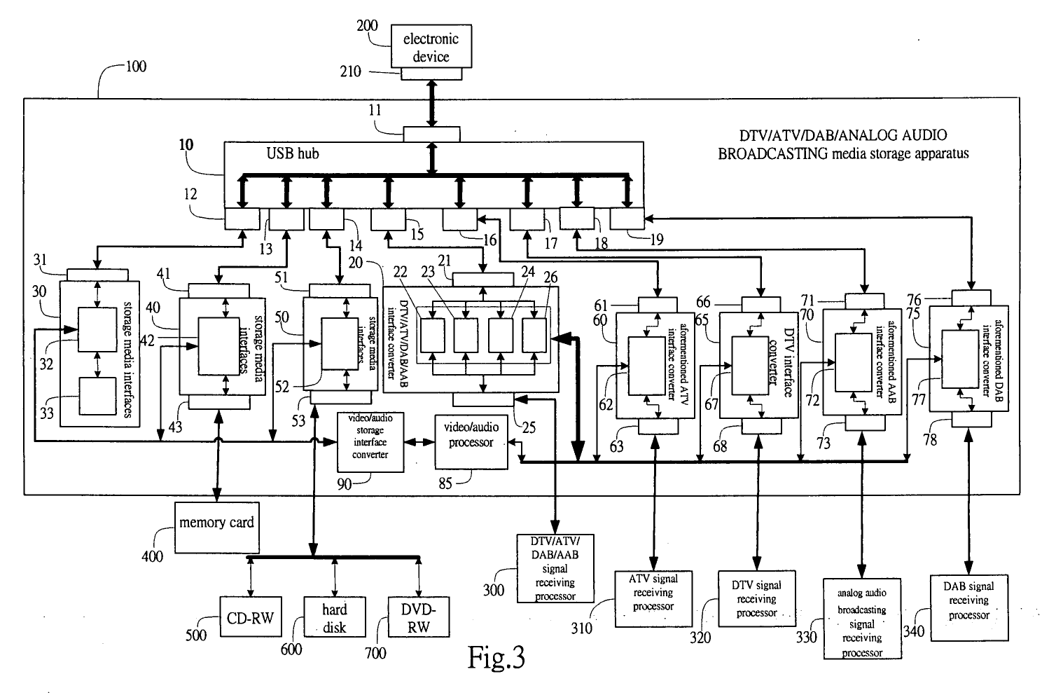

FIG. 3 shows a third embodiment of the present invention. A DTV/ATV/Dab/ANALOG AUDIO BROADCASTING media storage apparatus 100 comprises a USB hub 10, a DTV/ATV/DAB/ANALOG AUDIO BROADCASTING interface converter 20, and a plurality of storage media interfaces 30, 40, 50. The USB hub 10 comprises an upstream port 11 and a plurality of downstream ports 12, 13, 14, 15, 16, 17, 18, 19, 29. The upstream port 11 is connected to a USB interface 210 of an electronic device 200 for two-way data communication between the downstream ports 12-19 and the electronic device 200.

The aforementioned DTV/ATV/DAB/ANALOG AUDIO BROADCASTING interface converter 20 comprises a USB controller 21, a DTV signal processor 22, a DAB signal processor 23, an ATV signal processor 24, a signal input interface 25, and an ANALOG AUDIO BROADCASTING signal processor 26. The USB controller 21 is connected to the downstream port 15 of the USB hub 10 to form a USB-type two-way data communication between the DTV/ATV/DAB/ANALOG AUDIO BROADCASTING interface converter 20 and the USB hub 10. The DTV signal processor 22 provides the conversion of DTV signal into a format suitable for playing on the electronic device 200. The DTV signal processor 22 is connected to the USB controller 21, which is connected to the USB hub 10. The upstream port 11 of the USB hub 10 transmits the processed DTV data to the electronic device 200 for playing or storage.

The DAB signal processor 23 provides the conversion of DAB signal into a format suitable for playing on the electronic device 200. The DAB signal processor 23 is connected to the USB controller 21, which is connected to the USB hub 10. The upstream port 11 of the USB hub 10 transmits the processed DAB data to the electronic device 200 for playing or storage.

The ATV signal processor 24 provides the conversion of ATV signal into a format suitable for playing on the electronic device 200. The ATV signal processor 24 is connected to the USB controller 21, which is connected to The USB hub 10. The upstream port 11 of the USB hub 10 transmits the processed ATV data to the electronic device 200 for playing or storage.

The ANALOG AUDIO BROADCASTING signal processor 26 provides the conversion of ANALOG AUDIO BROADCASTING signal into a format suitable for playing on the electronic device 200. The ANALOG AUDIO BROADCASTING signal processor 26 is connected to the USB controller 21, which is connected to The USB hub 10. The upstream port 11 of the USB hub 10 transmits the processed ANALOG AUDIO BROADCASTING data to the electronic device 200 for playing or storage.

The aforementioned signal input interface 25 is externally connected to a DTV/ATV/DAB/ANALOG AUDIO BROADCASTING signal receiving processor 300. The DTV/ATV/DAB/ANALOG AUDIO BROADCASTING signal receiving processor 300 is for receiving DTV/ATV/DAB/ANALOG AUDIO BROADCASTING signal from the providers. The signal input interface 25 is to multiplex the DTV/ATV/DAB/ANALOG AUDIO BROADCASTING signal. The signal input interface 25 is internally connected to the DTV signal processor 22, the DAB signal processor 23, the ATV signal processor 24, and the ANALOG AUDIO BROADCASTING signal processor 26 to provide DTV/ATV/DAB/ANALOG AUDIO BROADCASTING signals to the DTV signal processor 22, the DAB signal processor 23, the ATV signal processor 24, and the ANALOG AUDIO BROADCASTING signal processor 26 for signal processing, respectively.

The aforementioned ATV interface converter 60 comprises a USB controller 61, an ATV signal processor 62, and an ATV signal input interface 63. The USB controller 61 is connected to the downstream port 16 of the USB hub 10 to form a USB-type two-way data communication between the ATV interface converter 60 and the USB hub 10. The ATV signal processor 62 provides the conversion of ATV signal into a format suitable for playing on the electronic device 200. The ATV signal processor 62 is connected to the USB controller 61, which is connected to the USB hub 10. The upstream port 11 of the USB hub 10 transmits the processed ATV data to the electronic device 200 for playing or storage.

The aforementioned DTV interface converter 65 comprises a USB controller 66, a DTV signal processor 67, and a DTV signal input interface 68. The USB controller 66 is connected to the downstream port 17 of the USB hub 10 to form a USB-type two-way data communication between the DTV interface converter 65 and the USB hub 10. The DTV signal processor 67 provides the conversion of DTV signal into a format suitable for playing on the electronic device 200. The DTV signal processor 67 is connected to the USB controller 66, which is connected to the USB hub 10. The upstream port 11 of the USB hub 10 transmits the processed DTV data to the electronic device 200 for playing or storage.

The aforementioned ANALOG AUDIO BROADCASTING interface converter 70 comprises a USB controller 71, an ANALOG AUDIO BROADCASTING signal processor 72, and an ANALOG AUDIO BROADCASTING signal input interface 73. The USB controller 71 is connected to the downstream port 18 of USB hub 10 to form a USB-type two-way data communication between the ANALOG AUDIO BROADCASTING interface converter 70 and the USB hub 10. The ANALOG AUDIO BROADCASTING signal processor 72 provides the conversion of ANALOG AUDIO BROADCASTING signal into a format suitable for playing on the electronic device 200. The ANALOG AUDIO BROADCASTING signal processor 72 is connected to the USB controller 71, which is connected to The USB hub 10. The upstream port 11 of the USB hub 10 transmits the processed ANALOG AUDIO BROADCASTING data to the electronic device 200 for playing or storage.

The aforementioned DAB interface converter 75 comprises a USB controller 76, a DAB signal processor 77, and a DAB signal input interface 78. The USB controller 76 is connected to the downstream port 19 of the USB hub 10 to form a USB-type two-way data communication between the DAB interface converter 75 and the USB hub 10. The DAB signal processor 77 provides the conversion of DAB signal into a format suitable for playing on the electronic device 200. The DAB signal processor 77 is connected to the USB controller 76, which is connected to the USB hub 10. The upstream port 11 of the USB hub 10 transmits the processed DAB data to the electronic device 200 for playing or storage.

The aforementioned storage media interfaces 30, 40, 50 are not limited to any specific type. In the present invention, the portable storage media interfaces, such as flash memory sticks, card reader, and ATA/ATAPI CD-RW and hard disk, are used as embodiment. Other equivalent portable storage media interfaces are also within the scope of the present invention. The storage media interface 30 comprises a USB controller 31, a flash memory access controller 32, and at least a flash memory 33. The USB controller 31 is connected to a downstream port 13 of the USB hub 10 to form a two-way USB-type data connection between the storage media interface 30 and the USB hub 10. The flash memory access controller 32 is to control the data access, and the flash memory 33 is connected to and controlled by the flash memory access controller 32. The aforementioned flash memory access controller 32 is connected to the USB controller 31 to transmit, through the USB hub 10, digital data converted by the DTV interface converter 65 to the electronic device 200 for playing or storage; alternatively, data processed, such as compression, filtering, and format conversion, by the electronic device 200 can be downloaded for storing in the flash memory 33. In addition, data can be compressed, filtered and/or format converted by the video/audio processor 85 and the video/audio storage interface converter 90 and then transmitted to the flash memory access controller 32 for storing in the flash memory 33 without going through the USB hub 10 and the electronic device 200. In this way, object of storing the DTV data in the portable flash memory storage media is achieved.

The aforementioned storage media interface 40 comprises a USB controller 41, a card reader controller 42, and a memory connector 43. The USB controller 41 is connected to a downstream port 14 of the USB hub 10 to form a two-way USB-type data connection between the storage media interface 40 and the USB hub 10. The card reader controller 42 is to control the data access, and the memory connector 43 is to provide external connection to at least a memory card 400. The memory card 400 can be CF/SD/MMC/XD/SM/MS/MSPRO/MS DUO, and so on, type of flash memory card. The memory connector 43 is connected to the card reader controller 42 so that the memory card 400 is controlled by the card reader controller 42. The aforementioned card reader controller 42 is connected to the USB controller 41 to transmit, through the USB hub 10, digital data converted by the DTV interface converter 65 to the electronic device 200 for playing or storage; alternatively, data processed, such as compression, filtering, and format conversion, by the electronic device 200 can be downloaded for storing in the memory card 400. In addition, data can be compressed, filtered and/or format converted by the video/audio processor 85 and the video/audio storage interface converter 90 and then transmitted laterally to the card reader controller 42 for storing in the memory card 400 without going through the USB hub 10 and the electronic device 200. In this way, object of storing the DTV data in the portable card reader storage media is achieved.

The aforementioned storage media interface 50 comprises a USB controller 51, an ATA/ATAPI interface controller 52, and a plurality of interface connectors 53, 54, 55. The USB controller 51 is connected to a downstream port 15 of the USB hub 10 to form a two-way USB-type data connection between the storage media interface 50 and the USB hub 10. The ATA/ATAPI controller 52 is to control the data access, and the interface connectors 53, 54, 55 are to provide external connection to a CD-RW 500, a hard disk 600, and a DVD-RW 700, respectively. The CD-RW 500, the hard disk 600, and the DVD-RW 700 have an ATA/ATAPI type interface. The interface connectors 53, 54, 55 are connected to the ATA/ATAPI controller 52 so that the CD-RW 500, the hard disk 600, and the DVD-RW 700 are controlled by the ATA/ATAPI controller 52. The aforementioned ATA/ATAPI controller 52 is connected to the USB controller 51 to transmit, through the USB hub 10, digital data converted by the DTV interface converter 65 to the electronic device 200 for playing or storage; alternatively, data processed, such as compression, filtering, and format conversion, by the electronic device 200 can be downloaded for storing in the CD-RW 500, the hard disk 600, and the DVD-RW 700. In addition, data can be compressed, filtered and/or format converted by the video/audio processor 85 and the video/audio storage interface converter 90 and then transmitted laterally to the ATA/ATAPI controller 52 for storing in the CD-RW 500, the hard disk 600, and the DVD-RW 700 without going through the USB hub 10 and the electronic device 200. In this way, object of storing the DTV data in the portable D-RW, hard disk, and DVD-RW storage media is achieved.

The aforementioned DTV interface converter 1065 comprises a USB endpoint interface 1066, a DTV signal processor 1067, and a DTV signal input interface 1068 .1USB endpoint interface 1066 is connected to the endpoint 17 of the USB SIE 1010 to provide conversion of DTV signal into a format suitable for playing on the electronic device 200. The DTV signal processor 1067 is connected to the USB endpoint interface 1066, which is connected to the USB SIE 1010. The upstream port 1011 of the USB SIE 1010 transmits the processed DTV data to the electronic device 200 for playing or storage.

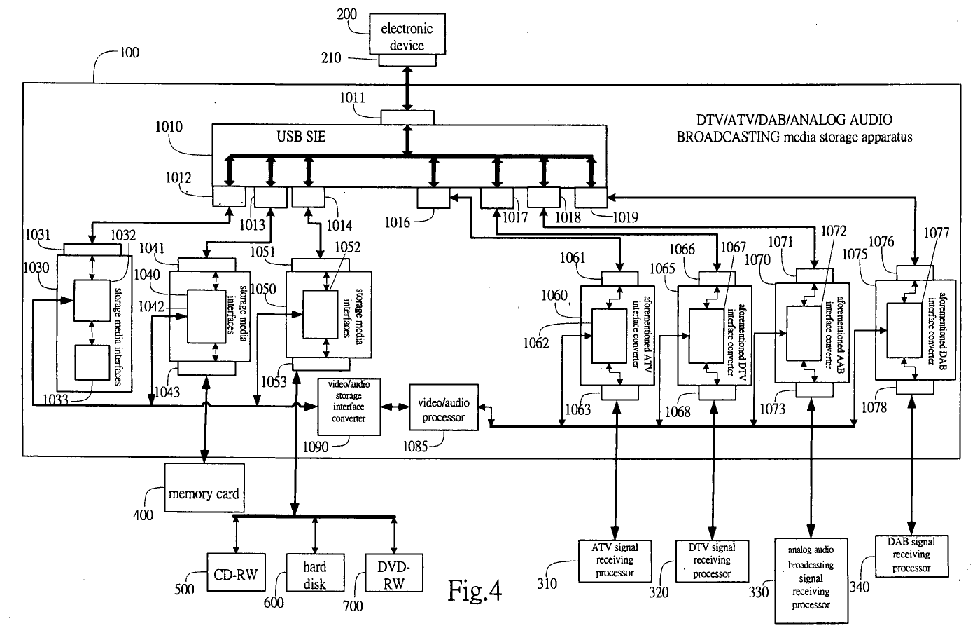

FIG. 4 shows a fourth embodiment of the present invention. A DTV/ATV/Dab/ANALOG AUDIO BROADCASTING media storage apparatus 100 comprises a USB serial interface engine (SIE) 1010, a DTV interface converter 1065, and a plurality of storage media interfaces 1030, 1040, 1050. The USB SIE 1010 comprises an upstream port 1011 and a plurality of endpoints 1012, 1013, 1014, 1016, 1017, 1018, 1019. The upstream port 1011 is connected to a USB interface 210 of an electronic device 200 for one-way/two-way data communication between the endpoints 1012, 1013, 1014, 1016, 1017, 1018, 1019 and the electronic device 200.

The aforementioned ATV interface converter 1060 comprises a USB endpoint interface 1061, an ATV signal processor 1062, and an ATV signal input interface 1063. The USB endpoint interface 1061 is connected to the endpoint 16 of the USB SIE 1010 to form a USB-type one-way/two-way data communication between the ATV interface converter 1060 and the USB hub 10. The ATV signal processor 1062 provides the conversion of ATV signal into a format suitable for playing on the electronic device 200. The ATV signal processor 1062 is connected to the USB endpoint interface 1061, which is connected to the USB SIE 1010. The upstream port 11 of the USB SIE 1010 transmits the processed ATV data to the electronic device 200 for playing or storage.

The aforementioned DTV interface converter 1065 comprises a USB endpoint interface 1066, a DTV signal processor 1067, and a DTV signal input interface 1068. The USB endpoint interface 1066 is connected to the endpoint 1017 of the USB SIE 1010 to form a USB-type one-way/two-way data communication between the DTV interface converter 1065 and the USB SIE 1010. The DTV signal processor 1067 provides the conversion of DTV signal into a format suitable for playing on the electronic device 200. The DTV signal processor 1067 is connected to the USB endpoint interface 1066, which is connected to the USB SIE 1010. The upstream port 11 of the USB SIE 1010 transmits the processed DTV data to the electronic device 200 for playing or storage.

The aforementioned ANALOG AUDIO BROADCASTING interface converter 1070 comprises a USB endpoint interface 1071, an ANALOG AUDIO BROADCASTING signal processor 1072, and an ANALOG AUDIO BROADCASTING signal input interface 1073. The USB endpoint interface 1071 is connected to the endpoint 1018 of the USB SIE 1010 to form a USB-type one-way/two-way data communication between the ANALOG AUDIO BROADCASTING interface converter 70 and the USB SIE 1010. The ANALOG AUDIO BROADCASTING signal processor 1072 provides the conversion of ANALOG AUDIO BROADCASTING signal into a format suitable for playing on the electronic device 200. The ANALOG AUDIO BROADCASTING signal processor 1072 is connected to the USB endpoint interface 1071, which is connected to the USB SIE 1010. The upstream port 11 of the USB SIE 1010 transmits the processed ANALOG AUDIO BROADCASTING data to the electronic device 200 for playing or storage.

The aforementioned DAB interface converter 1075 comprises a USB endpoint interface 1076, a DAB signal processor 1077, and a DAB signal input interface 1078. The USB endpoint interface 1076 is connected to the endpoint 1019 of the USB SIE 1010 to form a USB-type one-way/two-way data communication between the DAB interface converter 1075 and the USB SIE 1010. The DAB signal processor 1077 provides the conversion of DAB signal into a format suitable for playing on the electronic device 200. The DAB signal processor 1077 is connected to the USB endpoint interface 1076, which is connected to the USB SIE 1010. The upstream port 11 of the USB SIE 1010 transmits the processed DAB data to the electronic device 200 for playing or storage.

The aforementioned storage media interfaces 1030, 1040, 1050 are not limited to any specific type. In the present invention, the portable storage media interfaces, such as flash memory sticks, card reader, and ATA/ATAPI CD-RW and hard disk, are used as embodiment. Other equivalent portable storage media interfaces are also within the scope of the present invention. The storage media interface 1030 comprises a USB endpoint interface 1031, a flash memory access controller 1032, and at least a flash memory 1033. The USB endpoint interface 1031 is connected to an endpoint 13 of the USB SIE 1010 to form a one-way/two-way USB-type data connection between the storage media interface 1030 and the USB SIE 1010. The flash memory access controller 1032 is to control the data access, and the flash memory 1033 is connected to and controlled by the flash memory access controller 1032. The aforementioned flash memory access controller 1032 is connected to the USB endpoint interface 1031 to transmit, through the USB SIE 1010, digital data converted by the DTV interface converter 1065 to the electronic device 200 for playing or storage; alternatively, data processed, such as compression, filtering, and format conversion, by the electronic device 200 can be downloaded for storing in the flash memory 1033. In addition, data can be compressed, filtered and/or format converted by the video/audio processor 1085 and the video/audio storage interface converter 1090 and then transmitted to the flash memory access controller 1032 for storing in the flash memory 1033 without going through the USB SIE 1010 and the electronic device 200. In this way, object of storing the DTV data in the portable flash memory storage media is achieved.

The aforementioned storage media interface 1040 comprises a USB endpoint interface 1041, a card reader controller 1042, and a memory connector 1043. The USB endpoint interface 1041 is connected to an endpoint 1014 of the USB SIE 1010 to form a one-way/two-way USB-type data connection between the storage media interface 1040 and the USB SIE 1010. The card reader controller 1042 is to control the data access, and the memory connector 1043 is to provide external connection to at least a memory card 400. The memory card 400 can be CF/SD/MMC/XD/SM/MS/MSPRO/MS DUO, and so on, type of flash memory card. The memory connector 1043 is connected to the card reader controller 1042 so that the memory card 400 is controlled by the card reader controller 1042. The aforementioned card reader controller 1042 is connected to the USB endpoint interface 1041 to transmit, through the USB SIE 1010, digital data converted by the DTV interface converter 1065 to the electronic device 200 for playing or storage; alternatively, data processed, such as compression, filtering, and format conversion, by the electronic device 200 can be downloaded for storing in the memory card 400. In addition, data can be compressed, filtered and/or format converted by the video/audio processor 1085 and the video/audio storage interface converter 1090 and then transmitted laterally to the card reader controller 1042 for storing in the memory card 400 without going through the USB SIE 1010 and the electronic device 200. In this way, object of storing the DTV data in the portable card reader storage media is achieved.

The aforementioned storage media interface 1050 comprises a USB endpoint interface 1051, an ATA/ATAPI interface controller 1052, and a plurality of interface connectors 1053, 1054, 1055. The USB endpoint interface 1051 is connected to an endpoint 1015 of the USB SIE 1010 to form a one-way/two-way USB-type data connection between the storage media interface 1050 and the USB SIE 1010. The ATA/ATAPI controller 1052 is to control the data access, and the interface connectors 1053, 1054, 1055 are to provide external connection to a CD-RW 500, a hard disk 600, and a DVD-RW 700, respectively. The CD-RW 500, the hard disk 600, and the DVD-RW 700 have an ATA/ATAPI type interface. The interface connectors 1053, 1054, 1055 are connected to the ATA/ATAPI controller 1052 so that the CD-RW 500, the hard disk 600, and the DVD-RW 700 are controlled by the ATA/ATAPI controller 1052. The aforementioned ATA/ATAPI controller 1052 is connected to the USB endpoint interface 1051 to transmit, through the USB SIE 1010, digital data converted by the DTV interface converter 1065 to the electronic device 200 for playing or storage; alternatively, data processed, such as compression, filtering, and format conversion, by the electronic device 200 can be downloaded for storing in the CD-RW 500, the hard disk 600, and the DVD-RW 700. In addition, data can be compressed, filtered and/or format converted by the video/audio processor 1085 and the video/audio storage interface converter 1090 and then transmitted laterally to the ATA/ATAPI controller 1052 for storing in the CD-RW 500, the hard disk 600, and the DVD-RW 700 without going through the USB SIE 1010 and the electronic device 200. In this way, object of storing the DTV data in the portable CD-RW, hard disk, and DVD-RW storage media is achieved.

The aforementioned storage media interfaces 1030, 1040, 1050 are not limited to the individual circuit elements as shown in FIG. 4. The storage media interfaces 1030, 1040, 1050 can be integrated into an IC or a circuit module.

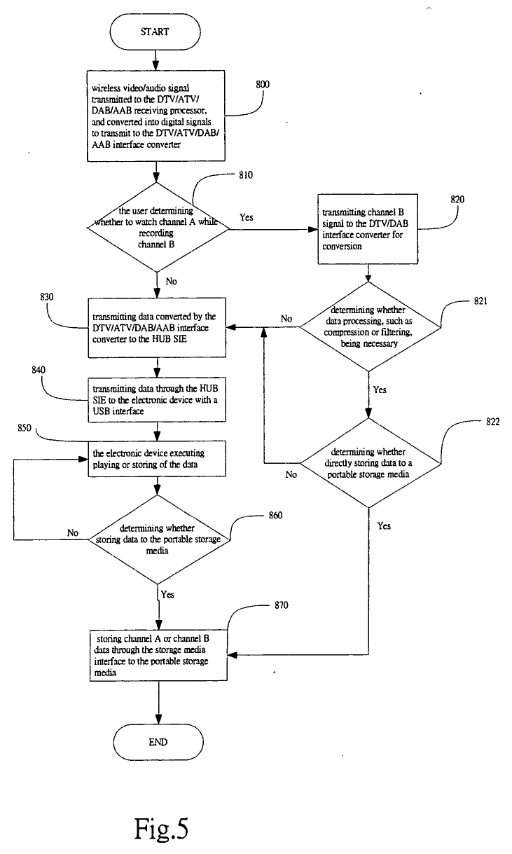

FIG. 5 shows a flowchart of the operation of the DTV/ATV/DAB/ANALOG AUDIO BROADCASTING media storage apparatus 100 of the present invention. The flowchart shows the on-the-fly recording of the program, and the direct compression and storing. The method includes the steps of:

(800) wireless video/audio signal transmitted to the DTV/ATV/DAB/ANALOG AUDIO BROADCASTING receiving processor, and converted into digital signals to transmit to the DTV/ATV/DAB/ANALOG AUDIO BROADCASTING interface converter;

(810) the user determining whether to watch channel A while recording channel B; if so, proceeding to step (820); otherwise, proceeding to step (830);

(820) transmitting channel B signal to the DTV/DAB interface converter for conversion;

(821) determining whether data processing, such as compression or filtering, being necessary; if so, proceeding to step (822); otherwise, proceeding to step (830);

(822) determining whether directly storing data to a portable storage media; if so, proceeding to step (870); otherwise, proceeding to step (830);

(830) transmitting data converted by the DTV/ATV/DAB/ANALOG AUDIO BROADCASTING interface converter to the HUB SIE; if not on-the-fly recording, transmitting only channel A signal to the DTV/DAB interface converter for conversion, and then to the HUB SIE; otherwise, transmitting both channel A signal and channel B signal to the DTV/DAB interface converter for conversion, and then to the HUB SIE;

(840) transmitting data through the HUB SIE to the electronic device with a USB interface;

(850) the electronic device executing playing or storing of the data; if not on-the-fly recording, transmitting channel A data to he electronic device for playing; otherwise, transmitting channel A data to the electronic device for playing and transmitting channel B data to the electronic device for storing;

(860) determining whether storing data to the portable storage media; if so, proceeding to step (870); otherwise, repeating step (850); and

(870) storing channel A or channel B data through the storage media interface to the portable storage media; if not on-the-fly recording, storing only channel A data to the portable storage media, such as, flash memory, memory card, CD-RW, DVD-RW, or hard disk; otherwise, transmitting channel A data to the electronic device for playing and storing channel B data to the portable storage media, such as, flash memory, memory card, CD-RW, DVD-RW, or hard disk.

The aforementioned steps (800)-(870) can be application software pre-stored in a computer. The method for controlling DTV/DAB on-the-fly recording or storing data directly to portable storage media is not limited to the aforementioned steps (800)-(870), and can be varied to use with other application software.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A storage apparatus for digital TV video/analog TV video/digital audio broadcasting/analog audio broadcasting media, comprising:
at least a USB hub, having an upstream port and a plurality of downstream ports, the upstream port being connected to a USB interface port of an electronic device;
at least a DTV/ATV/DAB/ANALOG AUDIO BROADCASTING interface converter having a USB controller interface, connected to one of the downstream ports of the hub, the DTV/ATV/DAB/ANALOG AUDIO BROADCASTING interface converter being connected to a DTV/ATV/DAB/ANALOG AUDIO BROADCASTING receiving processor through a DTV/ATV/DAV/ANALOG AUDIO BROADCASTING signal input interface for receiving DTV/ATV/DAB/ANALOG AUDIO BROADCASTING signal, the DTV/ATV/DAB/ANALOG AUDIO BROADCASTING signal being converted by the DTV/ATV/DAB/ANALOG AUDIO BROADCASTING interface converter, and transmitted to the electronic device for playing or storing; and
a plurality of storage media interfaces, connected respectively to the downstream ports and laterally to the DTV/ATV/DAB/ANALOG AUDIO BROADCASTING interface converter, the storage media interfaces being portable media storage interface for connecting to a portable storage media, respectively, for storing the DTV/ATV/DAB/ANALOG AUDIO BROADCASTING data transmitted from the DTV/ATV/DAB/ANALOG AUDIO BROADCASTING through the hub to the electronic device, after being processed, such as, compression, filtering, format conversion, by the electronic device to the portable storage media, or transmitting the data through the video/audio processor and video/audio interface converter to the storage media interface, and then to the portable storage media for storing.

2. The apparatus as claimed in claim 1, wherein the DTV/DAB interface converter further comprises:
a USB controller, connected to the downstream of the hub;
a DTV signal processor, connected to the USB controller to provide DTV signal conversion;
a DAB signal processor, connected to the USB controller to provide DAB signal conversion;
an ATV signal processor, connected to the USB controller to provide ATV signal conversion;
an ANALOG AUDIO BROADCASTING signal processor, connected to the USB controller to provide ANALOG AUDIO BROADCASTING signal conversion;
a signal input interface, connected to the DTV signal processor, the DAB signal processor, the DAB signal processor, the ANALOG AUDIO BROADCASTING signal processor and a DTV/ATV/DAB/ANALOG AUDIO BROADCASTING receiving processor for transmitting DTV/ATV/DAB/ANALOG AUDIO BROADCASTING signal received by the DTV/ATV/DAB/ANALOG AUDIO BROADCASTING receiving processor to the DTV signal processor, the ATV signal processor, the DAB signal processor, and the ANALOG AUDIO BROADCASTING signal processor; and
a video/audio data processor, connected to the DTV signal processor, the DAB signal processor, the DAB signal processor, and the ANALOG AUDIO BROADCASTING signal processor for processing, such as compression, filtering, or format conversion, DTV/ATV/DAB/ANALOG AUDIO BROADCASTING data from the DTV signal processor, the DAB signal processor, the DAB signal processor, and the ANALOG AUDIO BROADCASTING signal processor.

3. The apparatus as claimed in claim 1, wherein the storage media interface is a portable flash memory storage media interface.

4. The apparatus as claimed in claim 1, wherein the storage media interface further comprises:
a USB controller, connected to one of the downstream ports of the hub;
a flash memory access controller, connected to the USB controller for providing data access to the portable flash memory storage media; and
a flash memory, connected to and controlled by the flash memory access controller.

5. The apparatus as claimed in claim 1, wherein the storage media interface is a portable card reader storage media interface.

6. The apparatus as claimed in claim 1, wherein the storage media interface further comprises:
a USB controller, connected to one of the downstream ports of the hub;
a card reader access controller, connected to the USB controller for providing data access to the portable card reader storage media; and
a memory connector, connected to a memory card and the card reader controller for enabling the memory card being controlled by the card reader access controller.

7. The apparatus as claimed in claim 1, wherein the storage media interface is a portable ATA/ATAPI-interfaced storage media interface.

8. The apparatus as claimed in claim 1, wherein the storage media interface further comprises:
a USB controller, connected to one of the downstream ports of the hub;
an ATA/ATAPI interface controller, connected to the USB controller for providing data access to the portable ATA/ATAPI-interfaced storage media; and
a plurality of interface connectors, connected to the ATA/ATAPI interface controller and a plurality of ATA/ATAPI-interfaced storage media for enabling the ATA/ATAPI-interfaced storage media being controlled by the ATA/ATAPI interface controller.

9. The apparatus as claimed in claim 8, wherein the ATA/ATAPI-interfaced storage media is a CD-RW, a DVD-RW, or a hard disk.

10. A storage apparatus for digital TV video/analog TV video/digital audio broadcasting/analog audio broadcasting media, comprising:
a USB serial interface engine (SIE), having a USB controller and a plurality of endpoints, an upstream port of the USB controller being connected to a USB interface port of an electronic device, the endpoints connected to a DTV/ATV/DAB/ANALOG AUDIO BROADCASTING interface converter having a USB endpoint interface, the DTV/ATV/DAB/ANALOG AUDIO BROADCASTING interface converter being connected to a DTV/ATV/DAB/ANALOG AUDIO BROADCASTING receiving processor through a DTV/ATV/DAV/ANALOG AUDIO BROADCASTING signal input interface for receiving DTV/ATV/DAB/ANALOG AUDIO BROADCASTING signal, the DTV/ATV/DAB/ANALOG AUDIO BROADCASTING signal being converted by the DTV/ATV/DAB/ANALOG AUDIO BROADCASTING interface converter, and transmitted to the electronic device for playing or storing; and
a plurality of storage media interfaces, connected respectively to the endpoints and laterally to the DTV/ATV/DAB/ANALOG AUDIO BROADCASTING interface converter, the storage media interfaces being portable media storage interface for connecting to portable storage media, respectively, for storing the DTV/ATV/DAB/ANALOG AUDIO BROADCASTING data transmitted from the DTV/ATV/DAB/ANALOG AUDIO BROADCASTING through the USB SIE to the electronic device, after being processed, such as, compression, filtering, format conversion, by the electronic device to the portable storage media, or transmitting the data through the video/audio processor and video/audio interface converter to the storage media interface, and then to the portable storage media for storing.

11. The apparatus as claimed in claim 10, wherein the DTV/DAB interface converter further comprises:
a USB endpoint interface, connected to the endpoint of the USB SIE;
a DTV signal processor, connected to the USB endpoint interface to provide DTV signal conversion;
a DAB signal processor, connected to the USB endpoint interface to provide DAB signal conversion;
an ATV signal processor, connected to the USB endpoint interface to provide ATV signal conversion;
an ANALOG AUDIO BROADCASTING signal processor, connected to the USB endpoint interface to provide ANALOG AUDIO BROADCASTING signal conversion;
a signal input interface, connected to the DTV signal processor, the DAB signal processor, the DAB signal processor, the ANALOG AUDIO BROADCASTING signal processor and a DTV/ATV/DAB/ANALOG AUDIO BROADCASTING receiving processor for transmitting DTV/ATV/DAB/ANALOG AUDIO BROADCASTING signal received by the DTV/ATV/DAB/ANALOG AUDIO BROADCASTING receiving processor to the DTV signal processor, the DAB signal processor, the DAB signal processor, and the ANALOG AUDIO BROADCASTING signal processor; and
a video/audio data processor, connected to DTV signal processor, the DAB signal processor, the DAB signal processor, and the ANALOG AUDIO BROADCASTING signal processor for processing, such as compression, filtering, or format conversion, DTV/ATV/DAB/ANALOG AUDIO BROADCASTING data from DTV signal processor, the DAB signal processor, the DAB signal processor, and the ANALOG AUDIO BROADCASTING signal processor.

12. The apparatus as claimed in claim 10, wherein the storage media interface is a portable flash memory storage media interface.

13. The apparatus as claimed in claim 10, wherein the storage media interface further comprises:
a USB endpoint interface, connected to one of the endpoints of the USB SIE;
a flash memory access controller, connected to the USB endpoint interface for providing data access to portable flash memory storage media; and
a flash memory, connected to and controlled by the flash memory access controller.

14. The apparatus as claimed in claim 10, wherein the storage media interface is a portable card reader storage media interface.

15. The apparatus as claimed in claim 10, wherein the storage media interface further comprises:
a USB endpoint interface, connected to one of the endpoints of the USB SIE;
a card reader access controller, connected to the USB endpoint interface for providing data access to portable card reader storage media; and
a memory connector, connected to a memory card and the card reader controller for enabling the memory card being controlled by the card reader access controller.

16. The apparatus as claimed in claim 10, wherein the storage media interface is a portable ATA/ATAPI-interfaced storage media interface.

17. The apparatus as claimed in claim 10, wherein the storage media interface further comprises:
a USB endpoint interface, connected to one of the endpoints of the USB SIE;
an ATA/ATAPI interface controller, connected to the USB endpoint interface for providing data access to portable ATA/ATAPI-interfaced storage media; and
a plurality of interface connectors, connected to the ATA/ATAPI interface controller and a plurality of ATA/ATAPI-interfaced storage media for enabling the ATA/ATAPI-interfaced storage media being controlled by the ATA/ATAPI interface controller.

18. The apparatus as claimed in claim 17, wherein the ATA/ATAPI-interfaced storage media is a CD-RW, a DVD-RW or a hard disk.
